(19) United States
(12) Patent Application Publication
(10) Pub. No.: US 2025/0153783 A1
(43) Pub. Date: May 15, 2025

(54) CONFIGURABLE WORK OR STORAGE PLATFORM FOR USE WITH A TRUCK OR TRAILER

(71) Applicants: Johnathan Friess, Germantown, WI (US); Zachary Brooks, Richfield, WI (US); Thomas C. Marshall, Hartland, WI (US)

(72) Inventors: Johnathan Friess, Germantown, WI (US); Zachary Brooks, Richfield, WI (US); Thomas C. Marshall, Hartland, WI (US)

(73) Assignee: Cynergi3 West, LLC, Phoenix, AZ (US)

(21) Appl. No.: 19/019,669

(22) Filed: Jan. 14, 2025

Related U.S. Application Data
(63) Continuation of application No. PCT/US2023/027815, filed on Jul. 14, 2023.
(60) Provisional application No. 63/389,262, filed on Jul. 14, 2022.

(51) Int. Cl. B62D 33/04; B60J 5/00; B62D 27/00

(52) U.S. Cl. CPC B62D 33/04; B60J 5/00; B62D 27/00

(57) ABSTRACT

A modular configurable work or storage platform for mountable to a trailer or vehicle chassis is provided. The platform includes a plurality of modular portions interconnected to one another to provide a top surface. The modular portions may include a storage cavity in which objects may be stored. The modular portion may include a plurality of mounting apertures for mounting functional elements thereto.

### CROSS-REFERENCE TO RELATED PATENT APPLICATIONS

This patent application is a continuation of co-pending U.S. PCT Patent Application No. PCT/US2023/027815, filed Jul. 14, 2023, which is pending and claims the benefit of U.S. Provisional Patent Application No. 63/389,262, filed Jul. 14, 2022. The teachings and disclosure of each application are incorporated herein by reference thereto in their entireties.

### FIELD OF THE INVENTION

This invention generally relates to trailers or trucks.

### BACKGROUND OF THE INVENTION

The lawncare industry performs numerous activities including, but not limited to, mowing, landscaping, fertilizing, snow removal, patio installation, etc. These different activities typically require specific tools for performance including, but not limited to, push and riding mowers, fertilizer spreaders, hoses, shovels, leaf blowers, rakes, sprinklers, wheelbarrows, trash cans, fuel cans, generators, mini excavators, aerators, snow blowers, line trimmers, pole saws, chain saws, cement mixers, etc. The various different activities can also require hauling various objects to or from a job site including, but not limited to, soil, mulch, sand, fertilizer, salt, plants to be planted (e.g. trees, flowers, etc.) and waste objects (e.g. branches, grass clippings, old concrete or paver blocks, logs, limbs, dead bushes, etc.).

Due to the large variety of objects transported to and from a job site, numerous different vehicles and trailers are often employed. However, the current work force may have difficulty or be prevented legally from driving the necessary vehicle or have the skills to maneuver the vehicle and/or any attached trailer.

Further, many trailers or vehicles may be permanently configured for hauling a limited number of the necessary tools or objects on the job site such that the trailer or vehicle may not always be in service or may be completely out of service for an entire season (e.g. a vehicle/trailer configured for winter snow removal may not be in service during spring, summer and fall).

Also, typically, when a truck or trailer is sold to an end user the configuration and size of the truck or trailer is relatively fixed and modifications to the length and functional components thereof is highly limited such that the trailer or vehicle is dedicated or designed for relatively specific projects.

As such, there is a need for more flexibility in vehicles and trailers for use in the lawncare industry both from a user operation standpoint and an ability to be configured to transport the necessary objects for different projects.

### SUMMARY OF THE INVENTION

Embodiments of the application provide new and improved work or storage platforms for vehicles or trailers. In particular, embodiments provide new and improved modular platforms that allow for high customization of the resulting assembly.

In an example, a modular work or storage platform for mounting to a vehicle chassis or trailer is provided. The platform includes a superstructure formed from a plurality of module portions operably secured to one another. At least two of the plurality of module portions each having a top, the tops combine to form a top surface of the superstructure.

In one example, the tops that combine to form a top surface of the superstructure are configured to support a riding lawn mower.

In one example, each of the plurality of module portions includes a same mounting structure for attachment of functional elements to the super structure.

In one example, the mounting structure includes a plurality of rows of mounting apertures. Each row of the plurality of rows of mounting apertures includes at least one aperture in each of the plurality of module portions.

In one example, the rows of mounting apertures extend generally parallel to a center line of the superstructure that may be generally parallel to a center line of a truck or trailer frame to which the superstructure is mounted.

In one example, at least one functional element includes one or more of the following racks, cabinets, enclosures, dump bins, ladders, shelves, ramps and/or drawers. The functional elements may be mounted to the superstructure using the apertures.

In one example, at least one of the plurality of module portions is generally cuboid in shape and has a central storage region that is accessible from a side of the superstructure when the super structure is attached to a vehicle or trailer.

In one example, a door is attached to the module portion to selectively close the central storage region.

In one example, each of the module portions are independently formed from one another.

In one example, each of at least two adjacent module portions define a central storage region. The central storage regions are separated by a same wall portion.

In one example, at least one of the plurality of module portions is generally cuboid in shape and has a central region that is accessible from a side of the superstructure when the super structure is attached to a vehicle or trailer.

In one example, the plurality of module portions includes a first module portion and a second module portion. The first module portion having a first top, a first bottom, and a first side member. The first top attaches to a top end of the first side member. The first bottom attaches to a bottom end of the first side member in spaced apart fashion. The second module portion has a second top, a second bottom, and a second side member. The second top attaches to a top end of the second side member. The second bottom attaches to a bottom end of the second side member in spaced apart fashion. A third member is connected to the first and second tops and is connected to the first and second bottom.

In one example, the first side member is a C-beam and the third side member is an I-beam.

In one example, the third member is an I-beam. The I-beam includes top flange portions that extend laterally outward relative to a top end of a web. The first top is positioned on top of one of the top flange portions and the second top is positioned on top of the other one of the top flange portions. The I-beam includes bottom flange portions that extend laterally outward relative to a bottom end of the web. The first bottom is positioned on top of one of the bottom flange portions and the second bottom is positioned on top of the other one of the bottom flange portions.

As such, the top flange portions are positioned vertically between associated top and bottoms. The bottom flange portions are below the bottoms.

In one example, the tops of the top flange portions face away from the bottom flange portions and the tops of the bottom flange portions face the top flange portions.

In one example, a backbone mounts underneath the superstructure and provides additional rigidity to the superstructure.

In one example, the backbone is configured to mount to the chassis of a vehicle or to the frame of a trailer.

In one example, the backbone includes separate sections that are interconnected by a support member extending substantially the entire length of the backbone.

In one example, the superstructure is mounted to a backbone. The backbone includes a first longitudinally extending trunk and a second longitudinally extending trunk extending parallel to the first longitudinally extending trunk. The backbone includes a plurality of laterally extending ladder braces attached at a first end to the first trunk and at a second end to the second trunk.

In one example, one of the ladder braces is aligned with an interface between two adjacent module portions.

In one example, the superstructure is mounted to a backbone. The backbone includes a first longitudinally extending trunk and a second longitudinally extending trunk extending parallel to the first longitudinally extending trunk. The backbone includes a plurality of laterally extending ladder braces attached at a first end to the first trunk and at a second end to the second trunk. One of the ladder braces is aligned with third member and the third member rests on top of the aligned ladder brace.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top and side perspective view of a configurable work or storage platform according to an example;

FIG. 2 is bottom and side perspective view of the platform of FIG. 1;

FIG. 3 is a side view of the superstructure of the platform of FIG. 1;

FIG. 4 is a perspective side view of the superstructure of the platform of FIG. 1;

FIG. 5 is an enlarged partial perspective side view of the superstructure of the platform of FIG. 1;

FIG. 6 is a top perspective illustration of the superstructure of the platform of FIG. 1;

FIGS. 7 and 8 are enlarged partial side illustrations of the superstructure of FIG. 6;

FIG. 9 is a top perspective illustration of a backbone for use with a superstructure;

FIG. 10 is an exploded illustration of the backbone of FIG. 9;

FIG. 11 is a perspective illustration of a top and side perspective view of a configurable work or storage platform mounted to a vehicle;

FIG. 12 is a further illustration of the configurable work or storage platform of FIG. 11 with an enclosure removed illustrating devices stored therein;

FIG. 13 is a cross-sectional illustration of the configurable work or storage platform of FIG. 11;

FIG. 14 is a top rear perspective illustration of the configurable work or storage platform of FIG. 11;

FIG. 15 is a bottom perspective illustration of the configurable work or storage platform of FIG. 11;

FIG. 16A is a perspective illustration of a configurable work or storage platform mounted to a trailer;

FIG. 16B is an exploded illustration of FIG. 16A with the platform removed from the chassis of the trailer;

FIG. 17 is a perspective illustration of the platform of FIG. 1 with the dump box tipped and ladder deployed;

FIG. 18 is a top perspective illustration of a further work platform;

FIG. 19 is a front view of the work platform of FIG. 18;

FIG. 20 is a side view of the work platform of FIG. 18;

FIG. 21 is a perspective illustration of a module portion of the work platform of FIG. 18;

FIG. 22 is a bottom perspective illustration of the module portion of FIG. 21; and

FIG. 23 is an exploded illustration of the module portion of FIG. 21.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

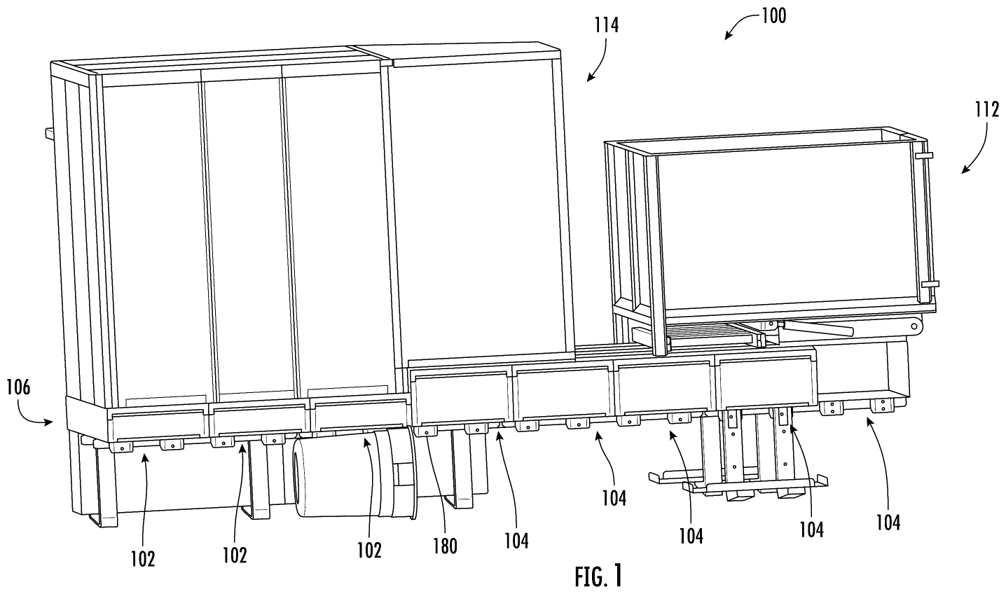

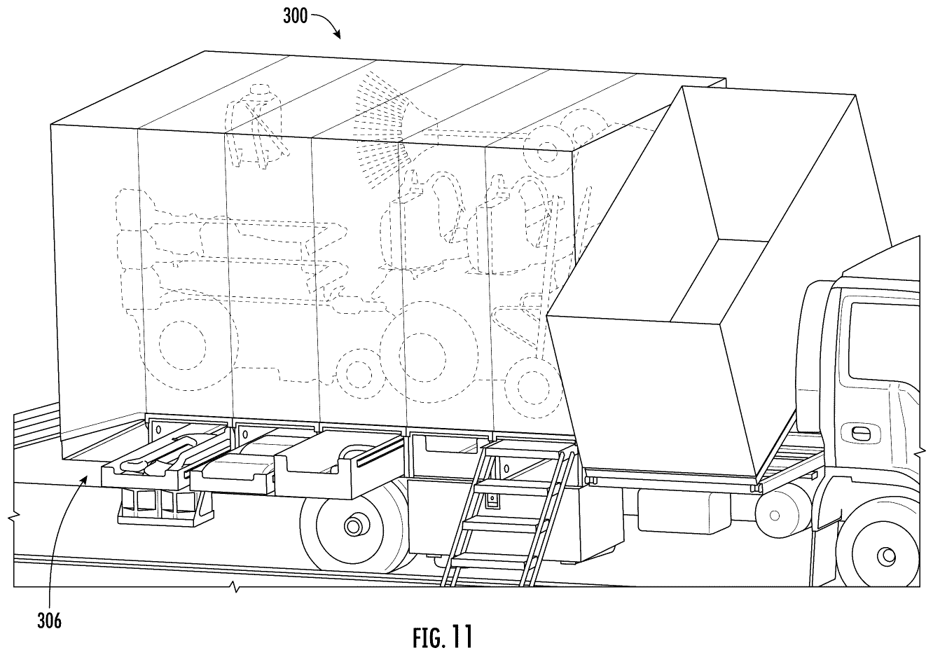

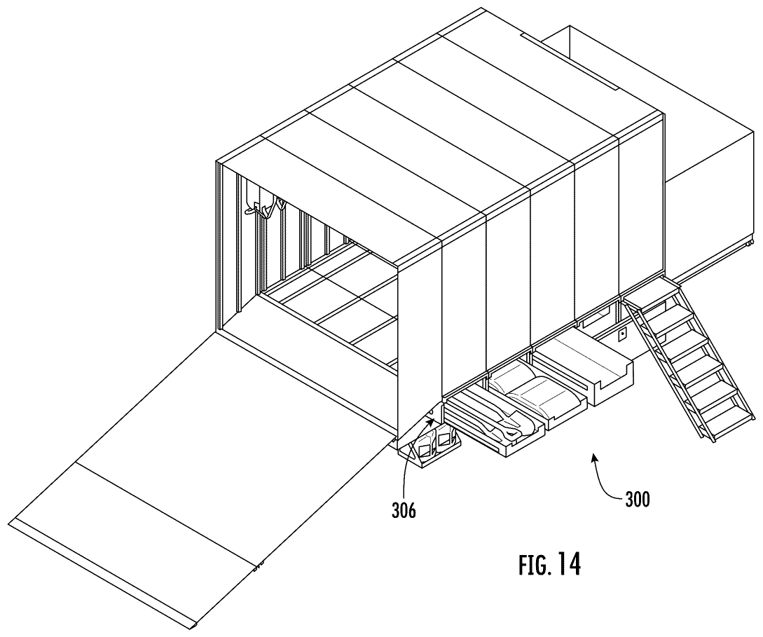

FIG. 1 illustrates an example of a configurable work and storage platform in a first platform configuration 100. The platform 100 has a plurality of module portions 102, 104. The plurality of module portions 102, 104 combine to form a superstructure 106 to which a plurality of functional elements such as drawers 108, racks 110, dump bins 112, ladders (see FIG. 11), ramps (see FIG. 14), enclosures 114, etc. may be mounted to configure the platform for different projects.

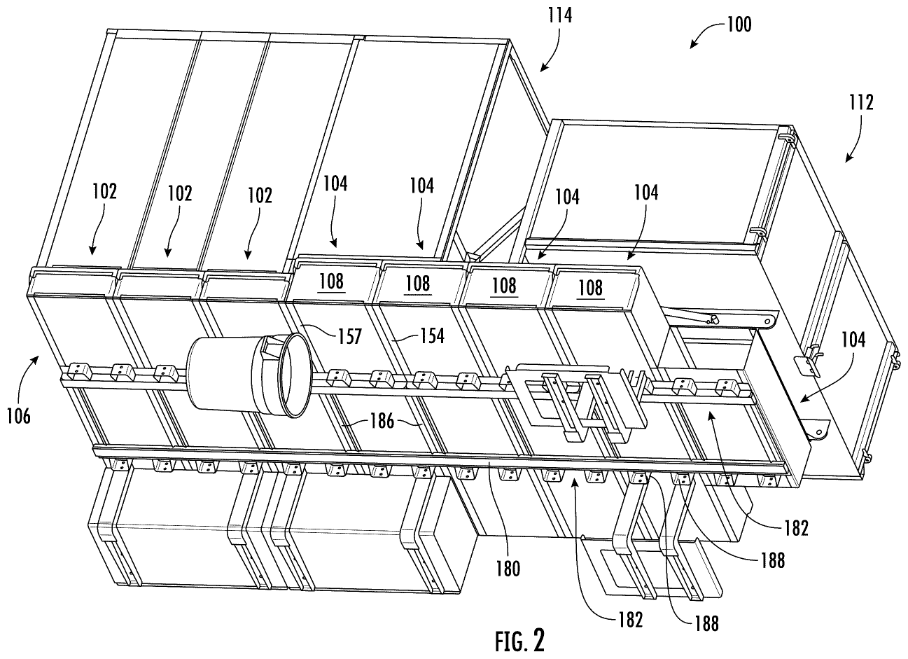

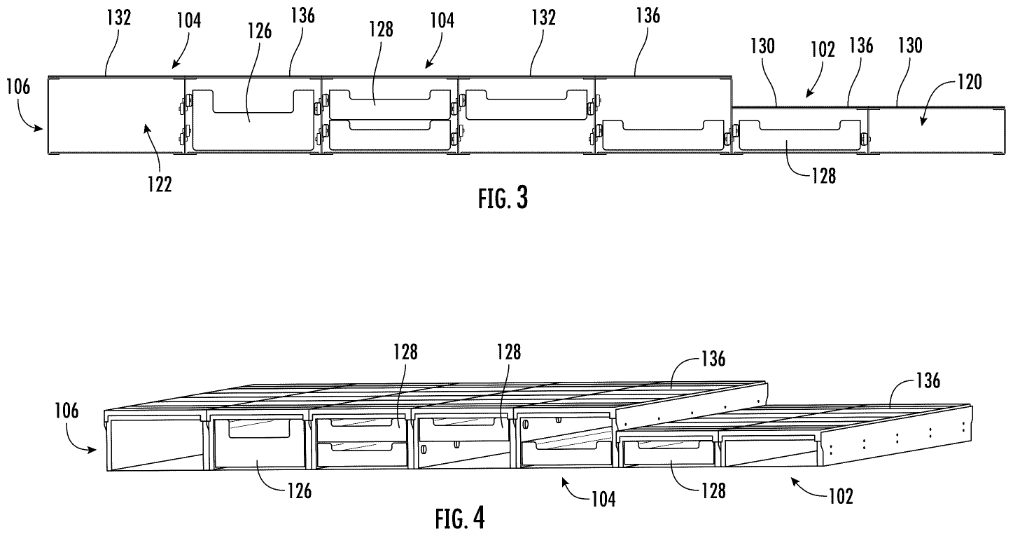

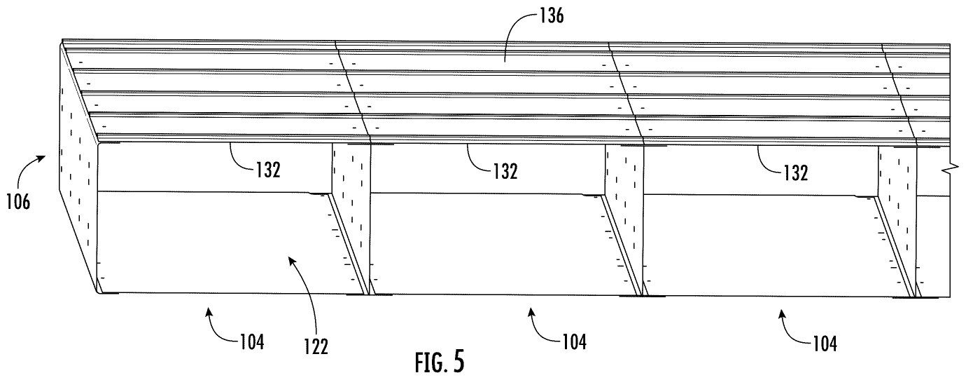

With reference to FIGS. 2-4, which illustrate a representative superstructure 106, in some examples, each module portion 102, 104 is generally a cuboid. The cuboid may define a central region 120, 122, which may be a cavity that may be used as a storage region. The central regions 120, 124 can include drawers 126, 128 or simply be empty storage regions.

The tops 130, 132 of the module portions 102, 104 can provide a top surface 136 sufficient to support tools such as riding lawn mowers, excavators, snow blowers, etc.

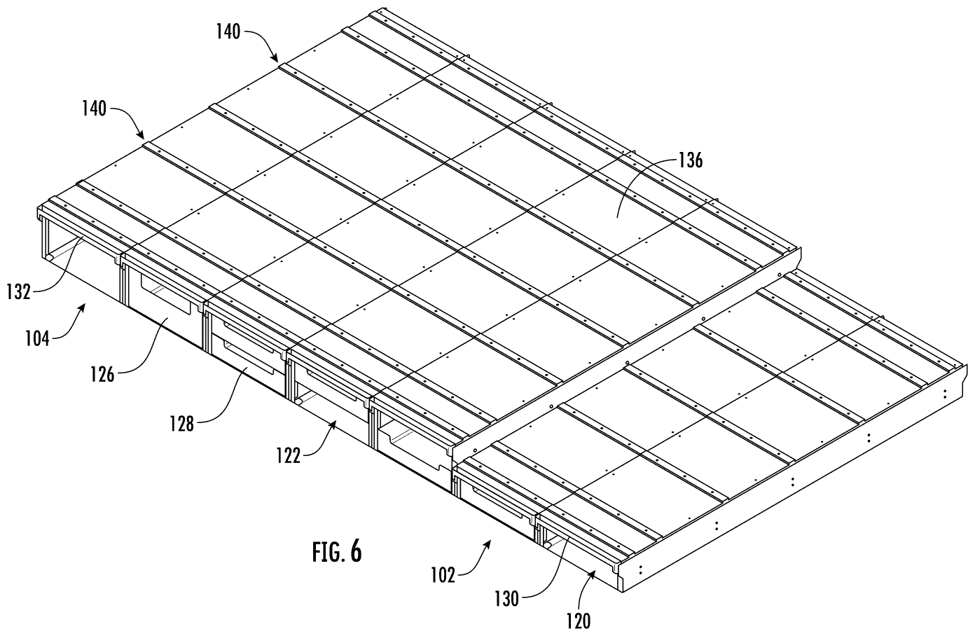

In some examples, as illustrated in FIG. 6, the tops 130, 132 of the module portions 102, 104 have identical bolt hole patterns for mounting the functional elements thereto. As illustrated in FIG. 6, there are a plurality of linear rows 140 of bolt holds. Each linear row 140 is formed in part by the plurality of different module portions 102, 104.

In some examples, each module portion is independent from one another. In such an example, each module portion has a top, an opposite bottom and a pair of opposed sides extending between the top and bottom in spaced apart fashion.

Fasteners such as bolts, screws, rivets, etc. may extend through adjacent sides of adjacent module portions to secure the adjacent portions together. In other examples, tie straps (e.g. rigid plates) may extend across the interface between adjacent module portions and be connected to both module portions to secure them together.

In other examples, such as illustrated in FIG. 7, each module portion 104 has its own top and bottom members 150, 152 but adjacent module portions 104 may share a side member 154. An end module portion such as module portion 104A in FIG. 7 may have a side member 156 that forms part of a single module portion 104.

For example, a single side member 154 may extend between the tops 150A, 150B and bottoms 152A, 152B of two adjacent module portions. In one particular example, where a single side member is used, the side member 154 may be in the form of an I-beam where the I-beam divides the storage regions 122A, 122B of the adjacent module portions 104A, 104B from one another but the I-beam is connected to top panels providing the tops 150A, 150B forming the top surface of both of the two adjacent module portions 104A, 104B. Similarly, the I-beam 154 is connected to the bottom panels providing the bottoms 152A, 152B forming the bottom surface of both of the two adjacent module portions 104A, 104B. This may be done by welding or by way of removable connections such as fasteners and more particularly such as by way of screws or bolts. Rivets may also be used. The I-beam configuration thus generally has four portions for supporting portions of each of two tops 150A, 150B and two bottoms 152A, 152B.

In this example, side member 156 is not an I-beam as it is not required to connect to or be part of an adjacent module portion 102, 104. Instead, the side member 156 is a C-beam that only needs to support one top 150A and one bottom 152A.

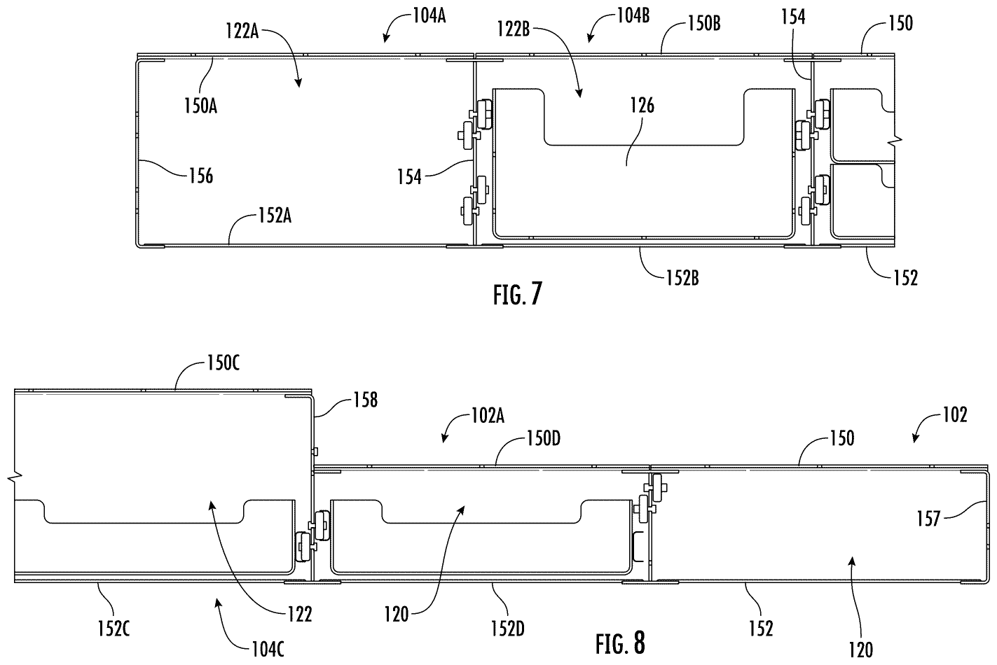

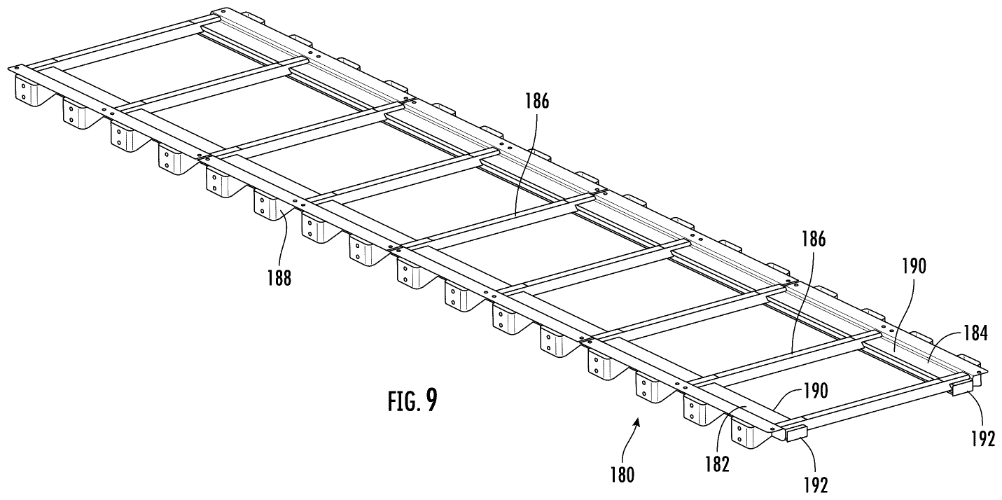

FIG. 8 illustrates a further side member 158 that is a combination of both an I-beam such as side member 154 and a C-beam such as side member 156. This side member is used to form parts of module portion 102A and module portion 102C that have different heights. Here a top most flange is used to connect to and support top 150C of module portion 104C. An intermediate flange that is in a middle of the web of the side member 158 is used to support and connect to top 150D of module portion 102A that is shorter than module portion 104C. Two bottom flanges that are at a same height are used to connect to and support bottom portions 152D, 152C of module portions 102A, 102C.

Side member 157 is similar to side member 156 but is shorter as it forms an end of a short module portion 102.

With the configuration above where adjacent module portions 102, 104, 102/104 are integrated together, the side members 154, 157 used to connect adjacent modules together provides increased rigidity in the superstructure. Further, by having the tops 150 above the laterally extending flange portions of the side members 154, 156, 157, a top continuous surface can be formed and adjacent top panels form the respective tops 150 can be butted up against one another.

In some examples, a plurality of the module portions have substantially identical dimensions in the front to back dimension, e.g. along the centerline of the truck or trailer to which it is associated. As illustrated, module portions 102 and 104 have such a same dimension.

In some examples, such as illustrated in FIGS. 4, 6, and 8, the height of adjacent module portions, such as between module portions 102, 104, may vary providing stepped transitions between adjacent module portions 102, 104 of different heights.

In some examples, a module portion may have a slanted top, see e.g. FIG. 11.

As illustrated in FIGS. 1, 2 and 9, a backbone 180 may be provided that is attached to one or more of the module portions 102, 104 and used to connect the superstructure 106 to the frame of a trailer or the frame of a vehicle. The backbone 180 can also provide additional strength to the attachment of adjacent module portions to one another.

The backbone 180 may also provide front to back rigidity to the super structure 106 as well as provide vertical rigidity proximate the interface between adjacent module portions 102, 104.

The backbone 180 itself may be modular so as to accommodate superstructures 106 formed from different number or sizes of module portions 102, 104. For example, if the front to back length of the module portions is 2 feet and 10 module portions are provided, a backbone may be formed from portions that are 5.5 feet long with ¼ foot of each portion overlapped and connected together. Alternatively, the backbone could be formed from portions that are 4.5 feet long with ¼ foot of each portion overlapped and connected together.

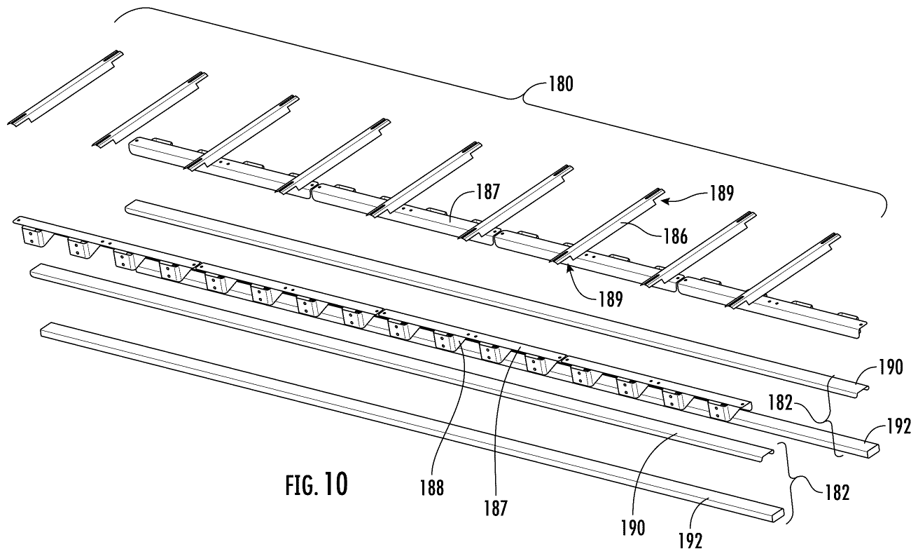

With particular reference to FIGS. 9 and 10, the backbone 180 may include a plurality of axially extending trunks 182 that generally run parallel to the longitudinal axis of the vehicle or trailer to which it is attached.

A plurality of cross-members in the form of ladder braces 186 may extend between and interconnect trunks 182. While not required, in some examples, the ends of the ladder braces 186 may be notched to the corresponding shape of frame mount tabs 187.

Each trunk may have a plurality of frame mount tabs 187, a plurality of accessory mounts 188, an elongated C-channel 190 and a reinforcing member 192. In this example, the reinforcing member 192 is received in the channel defined by C-channel 190.

The C-channel 190 and reinforcing member 192 run the entire length of the back bone 180. The reinforcing member 192, in some examples, is a piece of wood or metal such as a 4″×4″, 2″×4″ or 2″×6″.

The frame mount tabs 187 are operably attached to the C-channel 190 such as by way of fasteners or welding. Accessory mounts 188 are operably attached to the frame mount tabs 187, such as by fasteners or welding.

The plurality of accessory mounts 188 may be attached to the trunks 182, 184 for attachment of accessories such as in non-limiting example racks, shelves, bucket holders, cooler holders, shovel holders, wheelbarrow holders, tool holders, etc.

As illustrated in FIGS. 1 and 2, the backbone 180 is mounted to an underside of the superstructure 106. As illustrated in FIG. 1, preferably, the ladder braces 186 are aligned with the side members 154, 156, 157 of the superstructure 106 to provide further support thereto.

The backbone 180 may be attached to the superstructure 106 by bolts, screws or in some embodiments welding.

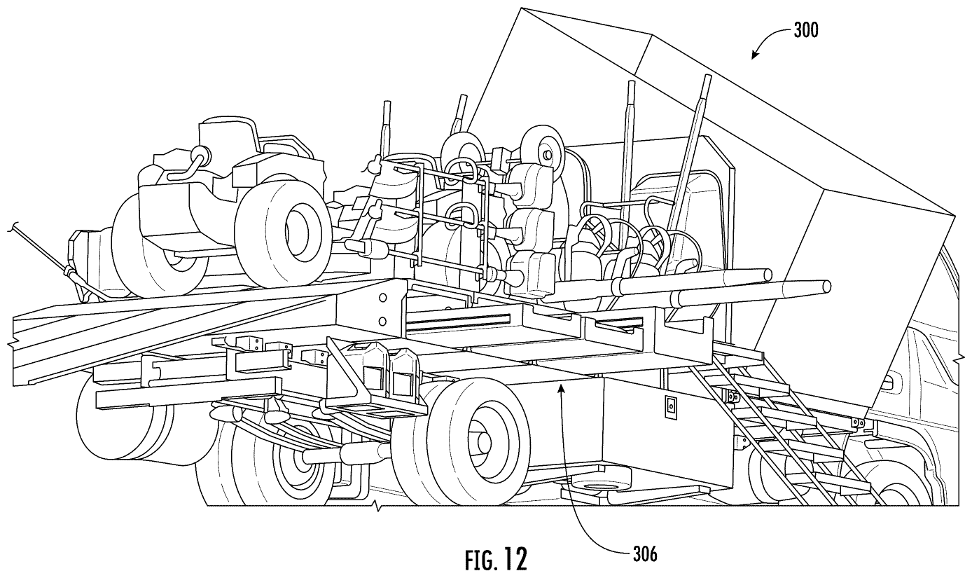

With reference to the configurable storage and work platforms 100, 300 and 500 of FIGS. 1, 2 and 11-17, functional elements may be mounted on top of, underneath or within the superstructure 106, 306, 506, respectively, formed by the module portions.

Some functional elements may include, in non-limiting example, tool chests or cabinets, racks for holding fuel cans, racks for holding lawn mowers and straps for holding garbage cans may be mounted underneath the super structure, e.g. to an underside of the superstructure 106 or to the accessory attachments 188 of the backbone 180.

In other examples, functional elements such as racks for line trimmers, pole saws, leaf blowers, wheelbarrows, chain saws, rakes, sprayers, spreaders, brooms, buckets, shovels, etc. may be mounted to the top side of the superstructure 106 provided by tops of the module portions.

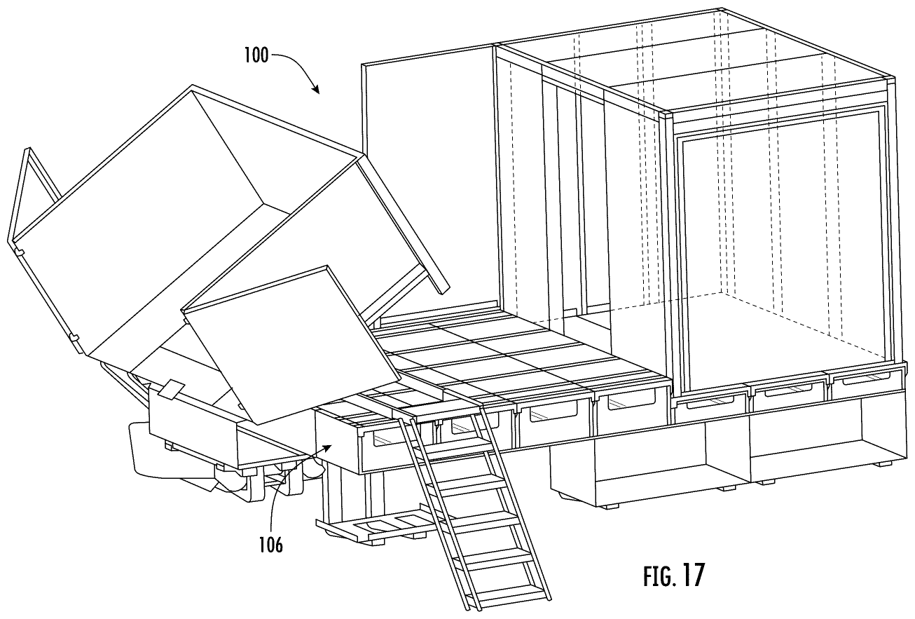

Dump bins may be mounted on top of the superstructure or be mounted to the end of the superstructure such as on an exposed portion of the backbone forward or rearward of the superstructure. Dump bins may pivot to dump off of an end of the superstructure (see FIG. 17) or may pivot to dump off of a side of the superstructure (see FIG. 11).

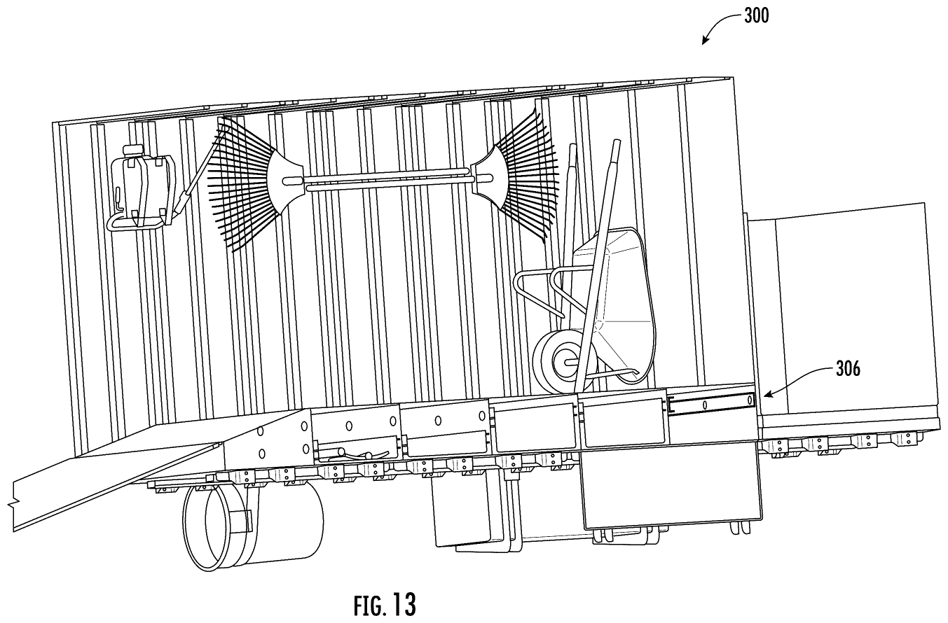

Enclosures (see FIGS. 1, 11, 14) may be mounted to the top of the superstructure for storing larger tools such as riding lawn mowers. The walls of such enclosures may include mounting structure for attaching functional elements such as racks for line trimmers, pole saws, leaf blowers, sprayers, spreaders, wheelbarrows, chain saws, buckets, rakes, brooms, shovels, etc. (see e.g. FIG. 13).

Similarly, the ceiling of an enclosure may provide mounting structure for attaching functional elements.

The enclosure itself may be modular so as to allow for various lengths, widths or heights that may be needed.

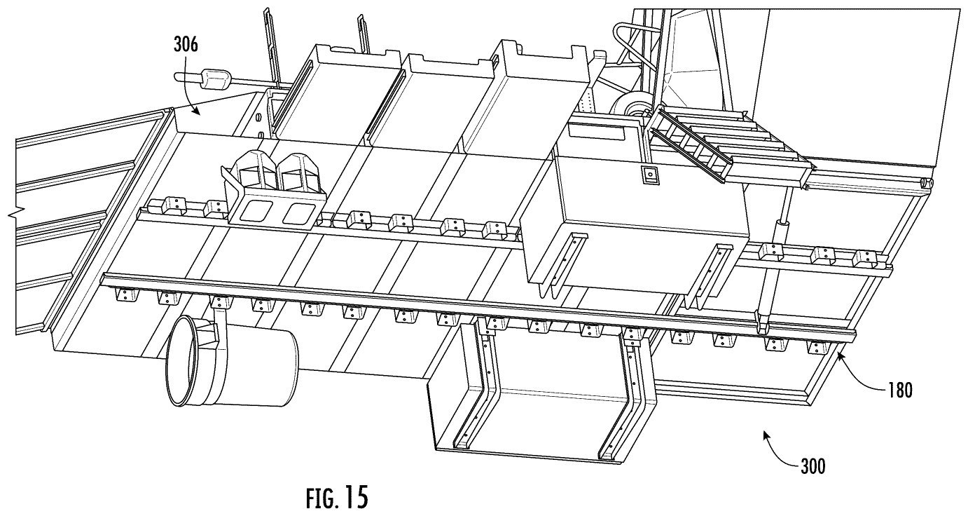

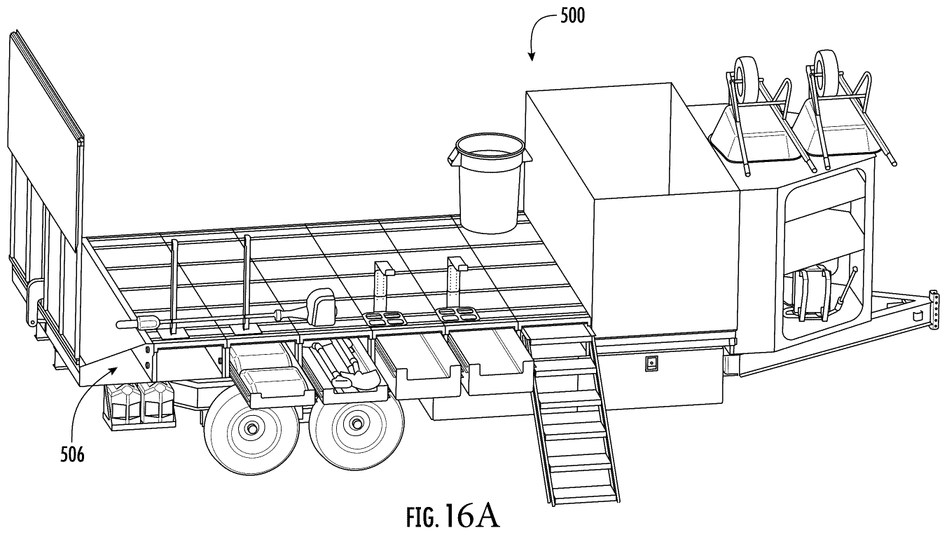

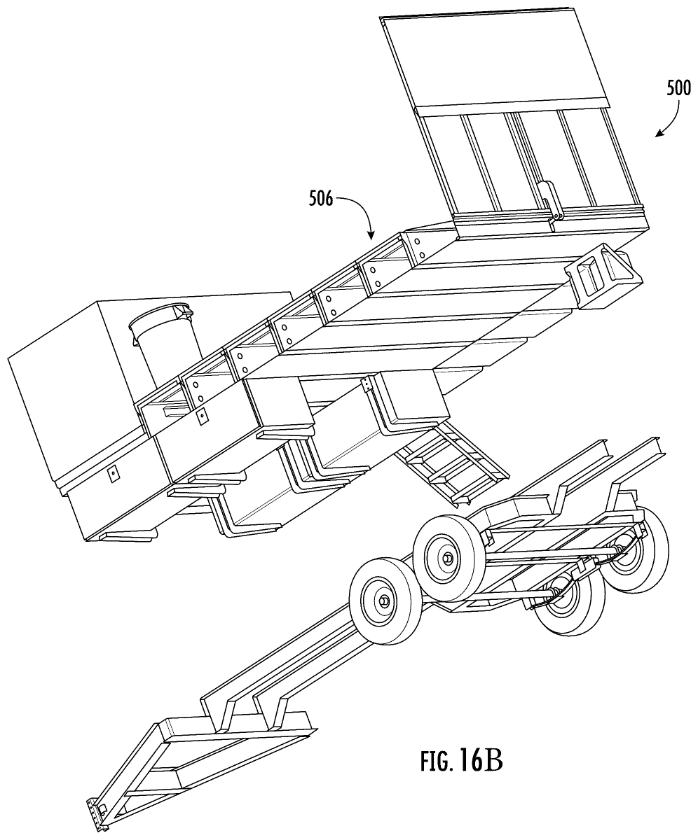

Again, the superstructure and/or backbone may be mounted to the chassis/frame of a vehicle (see FIG. 11) or to the chassis/frame of a trailer (see FIGS. 15, 16A, 16B). This allows for extreme flexibility in the configuration of such a platform.

Doors may be provided on or both of the ends of the storage regions provided by the modular portions 102, 104 to close the storage regions 120, 122 as needed.

It is a feature of examples that the platform may be reconfigured by changing which functional elements are mounted to the superstructure and/or by adding more or removing module portions from the superstructure. For example, different functional elements may be mounted to the different array of holes in the tops 150 of the module portions.

This configurability provides benefits to the end user as well as for the manufacturer.

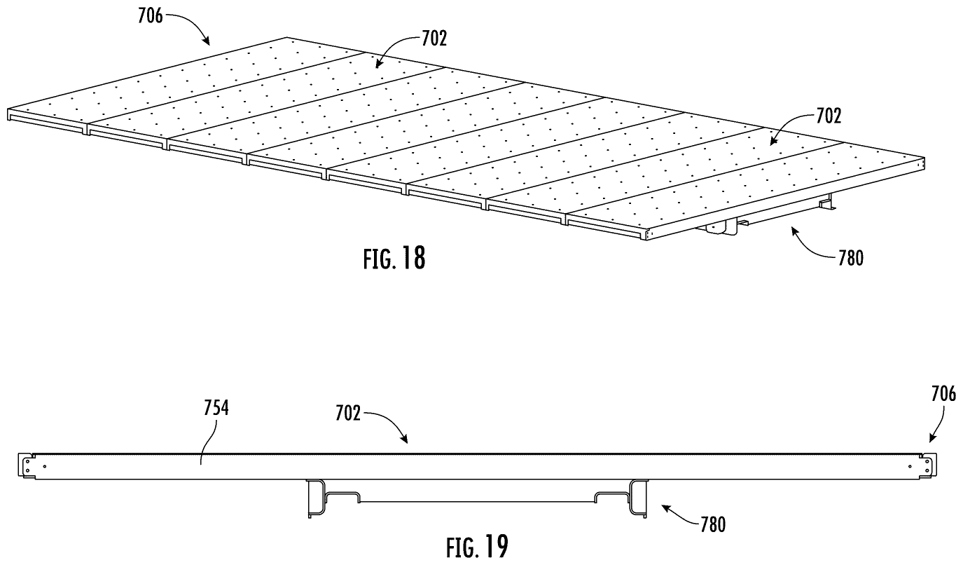

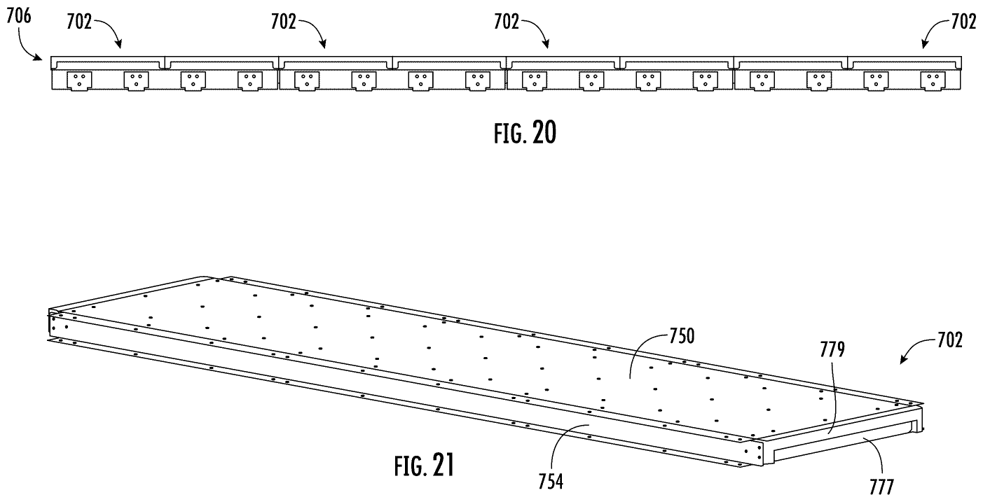

FIGS. 18-20 illustrate a further example where the superstructure 706 has a reduced height and includes module portions 702, all of which have a same height. The superstructure 706 is mounted to backbone 780. The superstructure 706 and backbone 708 are substantially the same as those described previously.

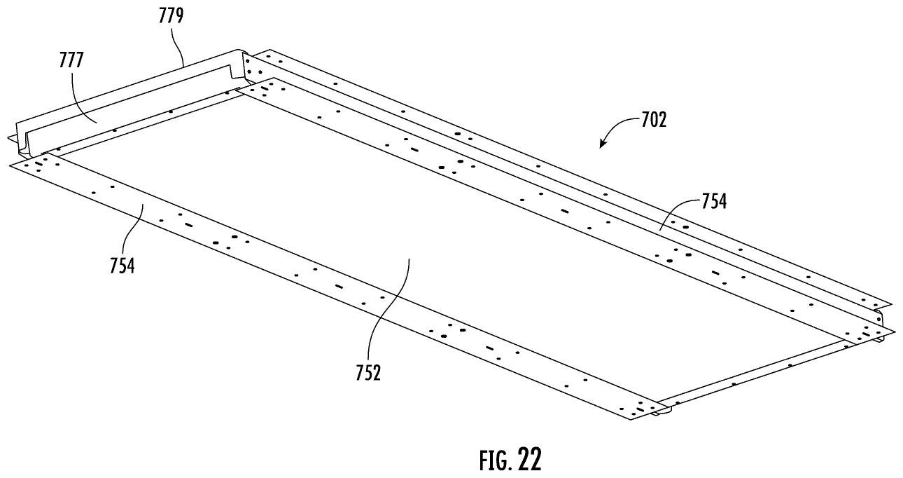

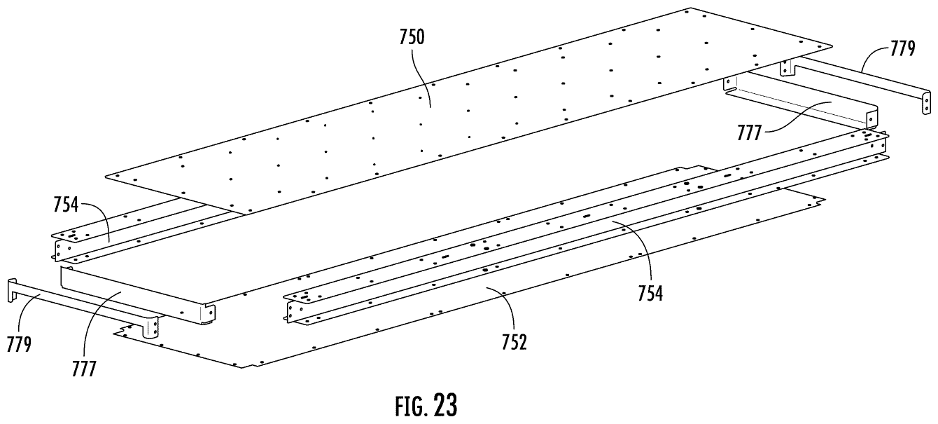

FIGS. 21-23 illustrate module portion 702. Here, this module portion 702 would be an intermediate portion and includes top 750, bottom 752, opposed side members 754. In this example, end caps 777 and brackets 779 that close the outer ends of the module portions 702. In prior embodiments these ends may have been open, closed by a door or provide access to a drawer mounted within the module portion 702.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A modular work or storage platform for mounting to a vehicle chassis or trailer comprising:
a superstructure formed from a plurality of module portions operably secured to one another, at least two of the plurality of module portions each have a top, the tops combining to form a top surface of the superstructure.

2. The platform of claim 1, wherein the tops that combine to form a top surface of the superstructure, the top surface configured to support a riding lawn mower.

3. The platform of claim 1, wherein each of the plurality of module portions includes a same mounting structure for attachment of functional elements to the super structure.

4. The platform of claim 3, wherein the mounting structure includes a plurality of rows of mounting apertures, each row of the plurality of rows of mounting apertures includes at least one aperture in each of the plurality of module portions.

5. The platform of claim 4, wherein the rows of mounting apertures extend generally parallel to a center line of the superstructure that may be generally parallel to a center line of a truck or trailer frame to which the superstructure is mounted.

6. The platform of claim 3, further comprising at least one functional element include one or more of the following:
racks, cabinets, enclosures, dump bins, ladders, shelves, ramps and/or drawers.

7. The platform of claim 1, wherein at least one of the plurality of module portions is generally cuboid in shape and has a central storage region that is accessible from a side of the superstructure when the super structure is attached to a vehicle or trailer.

8. The platform of claim 7, further comprising a door attached to the module portion to selectively close the central storage region.

9. The platform of claim 1, wherein each of the module portions are independently formed from one another.

10. The platform of claim 1, wherein each of at least two adjacent module portions define a central storage region, the central storage regions being separated by a same wall portion.

11. The platform of claim 10, wherein at least one of the plurality of module portions is generally cuboid in shape and has a central region that is accessible from a side of the superstructure when the super structure is attached to a vehicle or trailer.

12. The platform of claim 1, wherein:
the plurality of module portions includes a first module portion and a second module portion;
the first module portion having a first top, a first bottom, and a first side member, the first top attaches to a top end of the first side member, the first bottom attached to a bottom end of the first side member in spaced apart fashion;
the second module portion having a second top, a second bottom, and a second side member, the second top attaches to a top end of the second side member, the second bottom attached to a bottom end of the second side member in spaced apart fashion;
a third member is connected to the first and second tops and is connected to the first and second bottom.

13. The platform of claim 12, wherein:
the first side member is a C-beam; and
the third side member is an I-beam.

14. The platform of claim 12, wherein the third member is an I-beam including:
top flange portions that extend laterally outward relative to a top end of a web, the first top being positioned on top of one of the top flange portions and the second top being positioned on top of the other one of the top flange portions; and
bottom flange portions that extend laterally outward relative to a bottom end of the web, the first bottom being positioned on top of one of the bottom flange portions and the second bottom being positioned on top of the other one of the bottom flange portions.

15. The platform of claim 14, wherein the tops of the top flange portions face away from the bottom flange portions and the tops of the bottom flange portions face the top flange portions.

16. The platform of claim 1, further comprising a backbone mounted underneath the superstructure and providing additional rigidity to the superstructure.

17. The platform of claim 16, wherein the backbone is configured to mount to the chassis of a vehicle or to the frame of a trailer.

18. The platform of claim 1, wherein the superstructure is mounted to a backbone, the backbone includes a first longitudinally extending trunk and a second longitudinally extending trunk extending parallel to the first longitudinally extending trunk, and the backbone includes a plurality of laterally extending ladder braces attached at a first end to the first trunk and at a second end to the second trunk.

19. The platform of claim 18, wherein one of the ladder braces is aligned with an interface between two adjacent module portions.

20. The platform of claim 14, wherein:
the superstructure is mounted to a backbone, the backbone includes a first longitudinally extending trunk and a second longitudinally extending trunk extending parallel to the first longitudinally extending trunk, and the backbone includes a plurality of laterally extending ladder braces attached at a first end to the first trunk and at a second end to the second trunk; and
one of the ladder braces is aligned with third member and the third member rests on top of the aligned ladder brace.

21. The platform of claim 3, wherein the mounting structures are formed in a raised portion of the module portions.
